(19) United States
(12) Patent Application Publication
(10) Pub. No.: US 2008/0112755 A1
(43) Pub. Date: May 15, 2008

(54) Fillet for Picture Mat Board

(76) Inventor: David Muth Hadden, Los Altos, CA (US)

Correspondence Address: GLENN PATENT GROUP, 3475 EDISON WAY, SUITE L, MENLO PARK, CA, 94025, US

(21) Appl. No.: 11/558,577

(22) Filed: Nov. 10, 2006

(51) Int. Cl. E06B 3/984

(52) U.S. Cl. 403/401

(57) ABSTRACT

A preferred embodiment of the invention makes it faster and easier to mount fillets into a mat board. In this embodiment, the fillets are pre-joined into a self supporting rectangular assembly before mounting them into the aperture of a mat board. One embodiment of the invention provides a fillet and corner combination that keeps abutted fillets in perfect alignment in all axes and yet allows for slidable movement of each corner leg relative to the length of the each fillet into which a leg is inserted. This creates a flexible expansion joint, thus overcoming the problems with fillets rigidly affixed where they abut. An alternate embodiment of the invention provides a fillet assembly that is injection molded in one piece and that is flexed into locking abutment within an aperture formed in the mat board.

### BACKGROUND OF THE INVENTION

1. Technical Field

The invention relates to picture frames. More particularly, the invention relates to a method and apparatus for providing a fillet for a mat board in a picture frame.

2. Description of the Prior Art

Fillets are an essential design component in the art of picture framing. They are similar to small moldings, but with a fundamental difference: they have no rabbet or lip-like frame molding. Instead, there is a recessed back edge or shelf, which allows the fillet to be attached securely to the molding or matting using double-sided tape. Fillets are available in a range of sizes starting with visible widths as narrow as ⅛″ on up to 1¼″.

The popularity of fillets has grown at a tremendous pace in recent years. It was not too long ago that fillets were offered in just a few basic finishes and styles. They did not even necessarily coordinate with particular moldings. Today, fillets have become as sophisticated as the other components used in custom framing design. There are several ways fillets can be used. Each enhances the frame design, making it more interesting.

The purpose of framing is to enhance art. When fillets are used inside the mat board opening, they are more likely to keep the viewer's attention focused on the art than when a design is created without the fillet. Fillets have dimension that gives them visual weight. This helps create a sense of balance with the molding.

A mat board by itself cannot do that. Fillets also add a look of permanence and quality that upgrades the look of the art.

Fillets can be used individually, stacked together, or even turned and cut in reverse. They can be used to add to the appearance of the frame molding by fitting them under the rabbet of a frame. Fillets exist for the same reason as moldings or mats boards: to enhance the art and add a touch of creativity to a framing job. They can be used to add subtle sensations of color and texture to works of art and focus greater attention on the work itself.

Fillets have high visibility in artwork as they lead the transition from the artwork itself to the framing design which, in turn, leads to the environment in which the art work is displayed. For this reason, a properly fitted fillet of high quality is essential to a successful framing job. Cutting and fitting fillets is one of the most difficult jobs in framing a picture and requires a high degree of skill.

Currently, the following are the conventional steps taken when measuring and fitting a fillet in a mat board (see FIG. 1): The first step is to cut an aperture of the desired size in a mat board blank. A normal, undecorated mat board has the aperture cut with a bevel edge. However, when fitting a fillet 16 to a mat board 20, it is more desirable to cut what is referred to as a reverse bevel aperture 14. The next step is to measure each side of the mat board aperture accurately (see dimension “A” in FIG. 1). The selected fillet is then miter-cut into four lengths, each having exactly the same dimensions as the four sides of the mat board aperture. The fillet and mat board form a portion of a frame assembly that also includes a frame 10 having a frame profile 11, a protective transparent cover 15, such as conservation glass, a spacer 18 for spacing the glass from the artwork 17, frame sealing tape 19, an acid free mounting board 24, a backing board 23, and a dust cover 12, such as a brown craft paper dust cover.

FIG. 2 shows the point at which the aperture dimension “A” is measured on the mitered fillet. By placing double-sided adhesive tape on the underside of the mat board aperture, within 1/16″ of the cut edges, the four legs of the fillet can be secured to the mat board with the mitered ends fitting snugly up against each contiguous leg. FIG. 2 shows the visible area of the fillet 21 and the fillet shelf 22, which is adhered to the underside of the mat board.

At this point, filler strips of foam board or similar material are adhered to the underside of the mat board to level out the back surface. Once this is done, the exposed underside of the fillet is covered with an acid free tape. This tape should also cover a portion of the foam board filler strips.

Generally speaking, fillets are made out of wood. In recent years, fillets have been made from extruded plastic, but the quality of finish, range of designs, and the ability to create a quality corner fit has been limited. One extruded plastic fillet is U-shaped and fits over the edge of the aperture in a mat board board. This design does not require an adhesive, but is very difficult to fit and install because each of the four pieces must be installed separately, and the last piece must be bowed to install it and this bow is seen.

Recently, much of the lower end framing is being done by large chain stores which have hundreds of outlets. These stores buy in large volume and offer framing at substantially lower cost than the traditional frame shops that dominated framing in the past. They continue to take a significant amount of business from small individual frame shops. To offer the lowest possible cost for framing, these chains typically use relatively unskilled framers. How quickly and easily artwork can be framed is an important consideration.

### SUMMARY OF THE INVENTION

The invention can be used in a number of embodiments with various methods to solve a variety of problems. In one embodiment, it is faster and easier to mount fillets into a mat board if the fillets are pre-joined into a self supporting rectangular assembly before mounting them into the aperture of a mat board.

One embodiment of the invention overcomes the issues described above by providing a fillet and corner combination that keeps abutted fillets in perfect alignment in all axes and yet allows for slidable movement of each corner leg relative to the length of the each fillet into which a leg is inserted. This creates a flexible expansion joint, thus overcoming the problems with fillets rigidly affixed where they abut.

An alternate embodiment of the invention provides a fillet assembly that is injection molded in one piece and that is flexed into locking abutment within an aperture formed in the mat board.

While the invention described herein specifically addresses making it easier and less time consuming for relatively unskilled framers to use the described invention, it follows that more skilled framers in individual frame shops will also benefit from the improvements. While large chain stores are an important market, high volume framers who may frame 10,000 pictures at a time for mass markets such as hotel and restaurant chains can benefit because of the ease with which the described invention can be fully staged for assembly as will be discussed below.

### BRIEF DESCRIPTION OF THE DRAWINGS

FIG. 1 is a side sectional view of a frame assembly incorporating a fillet;

FIG. 2 is a plan view of a fillet assembly;

FIG. 3 is a perspective view that shows a set of four fillets and four corner inserts arranged in preparation for assembly according to the invention;

FIG. 4 is a perspective view that shows corner inserts inserted into the shorter set of fillets of FIG. 3 according to the invention;

FIG. 5 is a perspective view that shows the final step in assembling the four fillets of FIGS. 3 and 4 according to the invention;

FIG. 6 is a perspective view that shows the back side of a mat board with an aperture and double sided adhesive in place ready to receive the finished, joined fillets as an assembly according to the invention;

FIG. 7 is a perspective view that shows the front side of a completed mat board and fillet assembly, where FIG. 7A is a plan view that defines where a cross section of FIG. 7 is taken, and FIG. 7B is a sectional view that shows the cross section defined in FIG. 7A, each according to the invention;

FIG. 8 is a perspective view that shows one embodiment of a corner insert and the slot in the fillet into which it is inserted according to the invention;

FIG. 9 is a side and plan view that shows distortion that occurs when the fillet is cut by a chop saw;

FIG. 10 is a sectional view that shows typical dimensions for one fillet cross section according to the invention;

FIG. 11 shows three alternate cross sections of a fillet in relative scale according to the invention;

FIG. 12 is a perspective view that shows an alternate corner insert design with extended tips for easier positioning according to the invention;

FIG. 13 is a sectional view that shows that plastic can be extruded to form a fillet having a hollow profile according to the invention;

FIG. 14 is series of views showing an alternate embodiment of a corner insert and fillet profile that provide the necessary alignment of abutted fillets in all spatial axes and that still allows for slidable movement of each corner leg relative to the length of the each fillet into which a leg is inserted according to the invention;

FIG. 15 is a perspective view that shows a fillet assembly that is injection molded in one piece according to another embodiment of the invention;

FIG. 16 is a perspective view that shows the back side of the injection molded fillet assembly according to the invention;

FIG. 17 is a series of views which show the mat board in its flexed position according to the invention;

FIG. 18 is a perspective view that shows that the aperture for the mat board is cut to match the dimensions of the fillet undercut according to the invention; and

FIG. 19 is a plan view and a cross section of the fillet in its flexed position located within the aperture of the mat board according to the invention.

### DETAILED DESCRIPTION OF THE INVENTION

It is more difficult and requires more skill to secure individual fillets sequentially in a mat board because it is necessary to adhere the double sided adhesive around all sides of the aperture and then install fillets one-at-a-time. The difficulty herein is that the framer is handling and placing individual sections of fillet into careful alignment, especially where the fillet corners abut while working in close proximity to exposed adhesive. A small gap or misalignment from a corner fit being exactly 90 degrees is obvious to the eye and detracts from the esthetics of the picture frame.

A small error in placement requires that the fillet be carefully pulled from the adhesive and re-positioned. This can be tedious and difficult to do without damaging the adhesive layer or damaging the mat board. A preferred method is create a fillet assembly, with the corners already aligned and joined which can be installed in the mat board in a single step.

When larger fillets are used, some framers use V-nails to make a completed fillet assembly. Other framers glue fillets together first. This is time consuming and not desirable because mat board shrinks or expands relative to fillets based on temperature and relative humidity. Over time, fillets can come loose or mat boards can buckle. This is especially true when mat boards expand and there is no give where the fillet corners are rigidly attached to each other.

One embodiment of the invention overcomes these issues by providing a fillet and corner combination that keeps abutted fillets in perfect alignment in all axes and yet allows for slidable movement of each corner leg relative to the length of the each fillet into which a leg is inserted. This creates a flexible expansion joint thus overcoming the problems with fillets rigidly affixed where they abut.

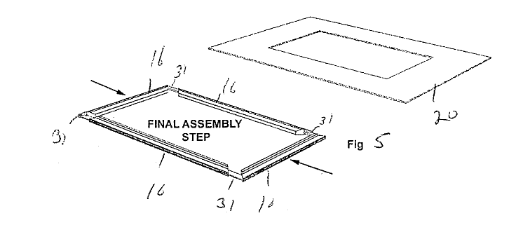

FIG. 3 shows a set of four fillets 16 and four corner inserts 31 arranged in preparation for assembly.

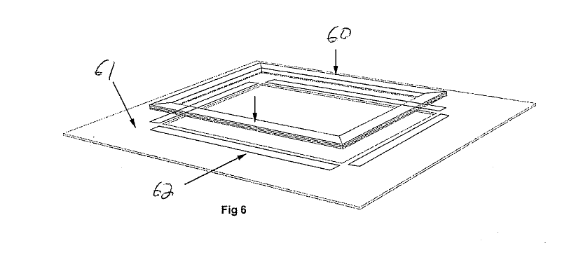

FIG. 4 shows corner inserts 31 inserted into the shorter set of fillets.

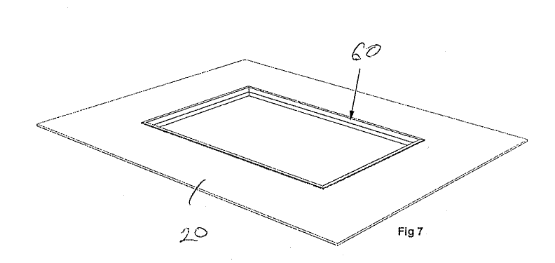

FIG. 5 shows the final step in assembling the four fillets.

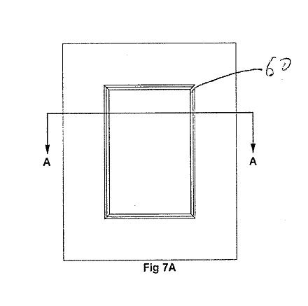

FIG. 6 shows the back side 61 of a mat board with an aperture and double sided adhesive 62 in place ready to receive the finished, joined fillets as an assembly 60.

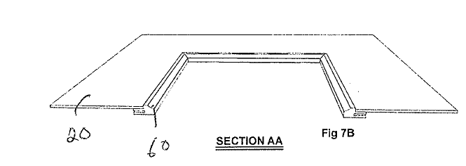

FIG. 7 shows the front side of a completed mat board 20 and fillet assembly 60. FIG. 7A defines where a cross section A-A of FIG. 7 is taken. FIG. 7B shows the cross section A-A defined in FIG. 7A

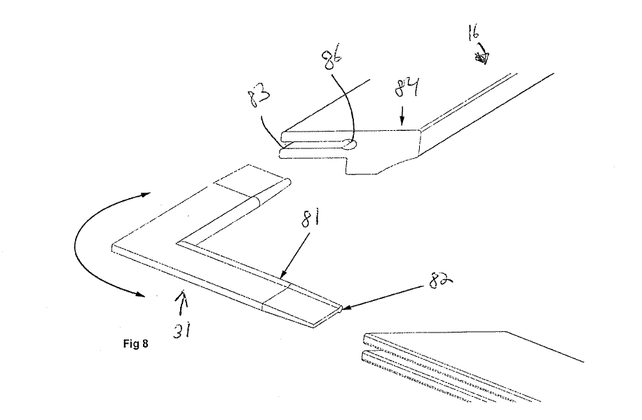

FIG. 8 shows one embodiment of a corner insert 31 and the slot 83 in the fillet 16 into which it is inserted. The back surface 84 of the fillet is prominent in FIG. 8. The ridge 81 on the insert is necessary to keep abutted fillets rigidly at 90 degrees in the plane of the fillet assembly. The insert also may have tapered ends 82 to allow for easy insertion into the fillet slot 83. Plastic is an ideal material for fillets because it can easily be extruded in profiles not possible to machine with wood. FIG. 8 shows an example of a fillet that has a gap with an extruded cylinder 86 whose diameter is larger than the gap. This would not be a practical profile for a wood fillet. Alternate profiles for the gap can be used to maintain a rigid positioning of the abutted fillets in all three spatial axes.

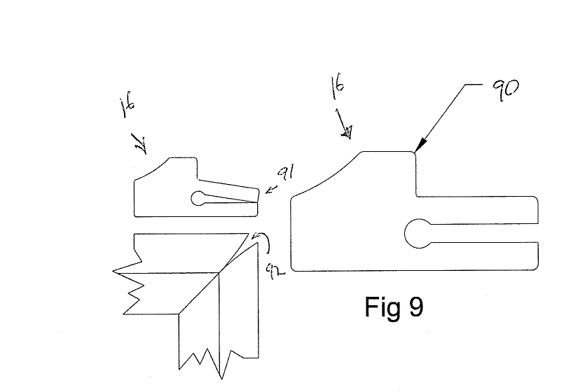

FIG. 9 shows distortion that occurs when the fillet is cut by a chopper saw. The direction of force from the chop saw 90 is indicated in FIG. 9. Many framing shops use a blade type chop saw to miter fillets to their appropriate length. These cutters exert considerable force on a fillet, thus distorting it during the cutting process. This produces a distorted cut so that the mitered edges do not meet properly. The distortion of the mitered cut increases as the chopper blade dulls, thus exacerbating the problem. One advantage of this invention is that the distortion 91 that occurs from flexing the fillet only causes a distortion in the mitered cut on that portion 92 which is under the mat board. The corner insert assures that the mitered fit of the non-distorted portion of the fillet is in tight abutment. The part under the mat board does not matter.

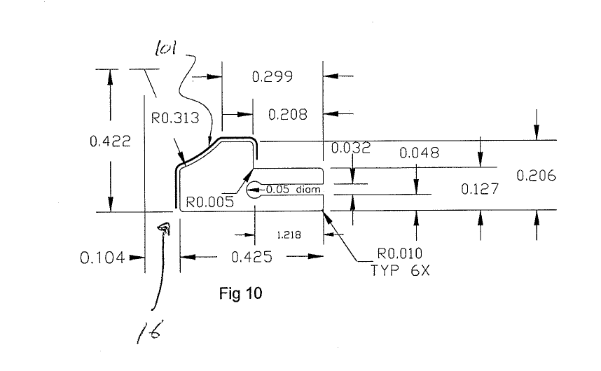

FIG. 10 shows typical dimensions for one fillet cross section. Typical, but not limited to, materials of construction are high impact polystyrene (HIPS), acrylo butadiene styrene (ABS). Those skilled in the art will appreciate that other materials may be used to make the fillet and that the fillet may be made in other dimensions as desired, all within the scope of the invention.

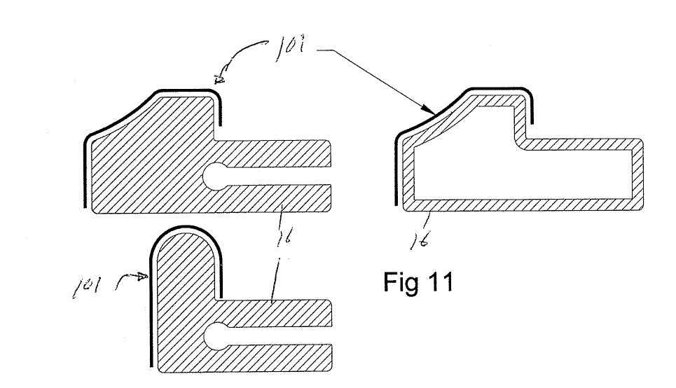

FIG. 11 shows three alternate cross sections of a fillet in relative scale. It should be appreciated that a fillet is a decorative item and that an unlimited variety of sizes and shapes can be used employing the methods of joining corners discussed herein. Thus, FIG. 11 shows various areas of the fillet 101 which may be hot stamped to receive a decorative impression.

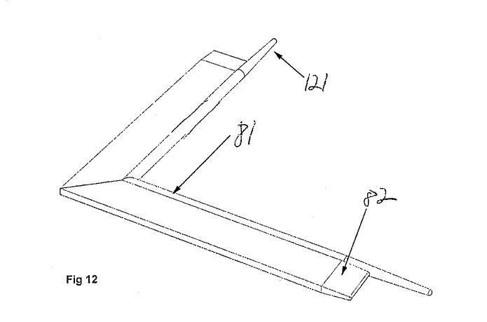

FIG. 12 shows an alternate corner insert design with extended tips 121 for easier positioning. Typical, but not limited to, materials of construction are high impact polystyrene (HIPS), acrylo butadiene styrene (ABS). Those skilled in the art will appreciate that other materials may be used to make the corner insert as desired, all within the scope of the invention.

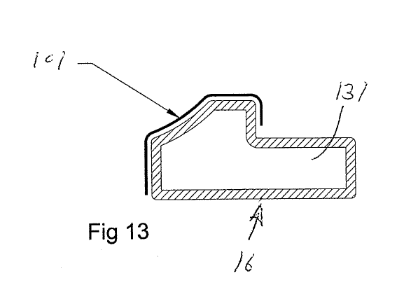

FIG. 13 shows that plastic can be extruded to form a fillet having a hollow profile 131. In FIG. 13, a simple “L” shaped corner insert is used to maintain alignment of abutted fillets in all spatial axes. Fillet decoration on most plastics is done using hot stamping which requires substantial pressure and heat which would permanently distort the profile of most fillets making hollow decorated profiles impractical.

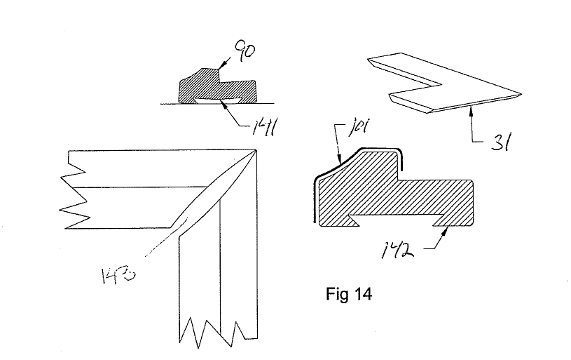

FIG. 14 is an alternate embodiment of a corner insert 31 and fillet profile 142 that provides the necessary alignment of abutted fillets in all spatial axes and that still allows for slidable movement of each corner leg relative to the length of the each fillet into which a leg is inserted. As discussed above, many framing shops use a blade type chop saw to miter fillets to their appropriate length. These chop saws exert considerable force 90 on a fillet thus distorting it 141 during the cutting process. This produces a distorted cut so that the mitered edges do not meet properly. The distortion of the mitered cut increases as the chop saw blade dulls, thus exacerbating the problem. Care must be taken when cutting this spacer with a chop saw as the fillet can flex into the dovetail causing a distorted cut 143 which disallows a seamless abutment of fillets at the corner.

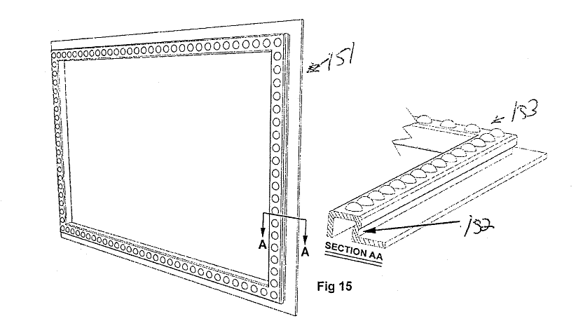

In another embodiment shown in FIG. 15, the fillet assembly 153 is injection molded in one piece. Rather than adhering the fillet in place with double sided adhesive, the fillet assembly is molded with a slight undercut in the range of 0.005 to 0.030-inches and flexed into position in the mat board to form a unitary assembly 151, thus eliminating the need for double sided adhesive. This undercut 152 can be seen in Section A-A in FIG. 15.

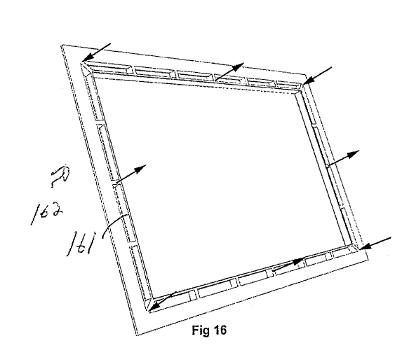

FIG. 16 shows the back side 162 of the injection molded fillet assembly. The arrows indicate the bending forces used to flex the fillet assembly so it can be installed into the mat board without damaging the mat board. Optional reinforcement ribs 161 provide rigidity to the fillet.

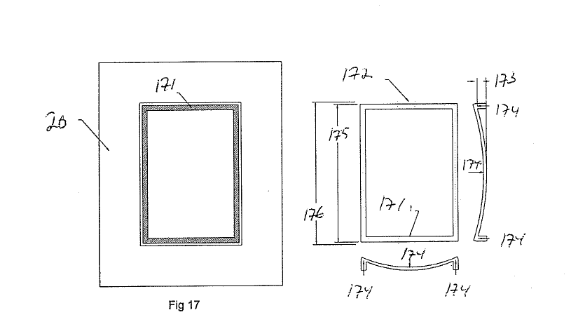

FIG. 17 shows the mat board in its flexed position. For clarity, the fillet shelf has not been shown. The dotted lines 172 in FIG. 17 show the molded fillet prior to flexing. The hatched entity 171 shown within the fillet aperture in FIG. 17 illustrates how a bending force 174 creates a flexing 173 of the fillet that allows it to be slipped into the mat board aperture and then released without damaging the mat board.

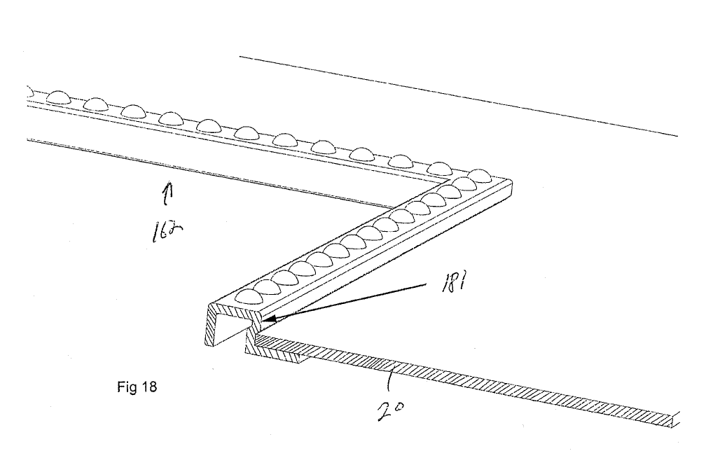

FIG. 18 shows a cross section of the fillet in its un-flexed position positioned within the aperture of the mat board. FIG. 18 shows that the aperture for the mat board 20 is cut to match the dimensions of the fillet undercut. When cut to these dimensions, the fillet can either be pressed into mat board where it is secured by the lip 181 resulting from the undercut or, the fillet assembly can be flexed, the mat board positioned and then the flexing forces on the fillet can be relaxed thus securing the fillet within the aperture.

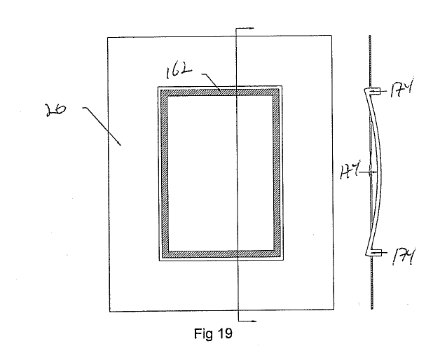

FIG. 19 shows a cross section of the fillet in its flexed position positioned within the aperture of the mat board. Fillet cross sectional profile details have not been included to simplify FIG. 19.

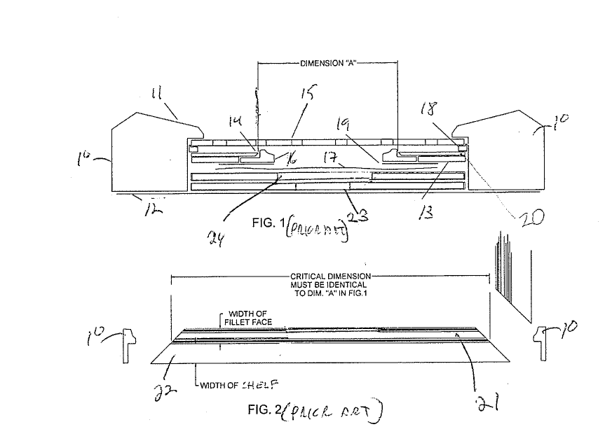

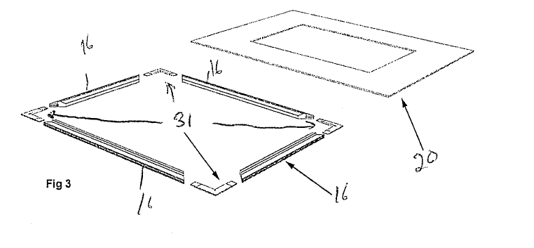

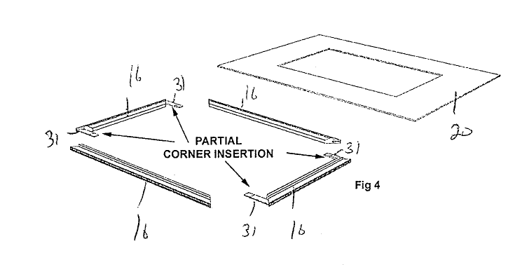

Another method of using the fillet and corner design of this invention involves first constructing a fillet assembly using the method described above and then cutting the correct aperture size in a mat board. Because the size of the aperture of a set of fillets surrounding a picture is dictated by the picture, and not by the frame or mat board, it follows that a properly sized fillet assembly can be constructed first. One advantage of this embodiment is that it is much easier and less confusing to measure the needed size of the mat board aperture from a fillet assembly than the reverse. Dimension A in FIG. 2 shows that the length of a fillet is measured not from end-to-end, but rather from a point somewhere along each 45 degree cut. Dimension A in FIG. 1 shows that once a fillet assembly is constructed, direct measurements can be made for the dimensions of the mat board aperture. This method thus provides that a fillet assembly is first constructed, the mat board aperture is determined next by direct measurement of the fillet assembly, and the fillet assembly is then affixed to the mat board as described earlier.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A fillet assembly for a picture frame mat board, comprising:
a plurality of fillet segments pre-joined into a self supporting polygonal assembly before mounting into a complementary aperture formed in a mat board, each of said fillet segments defining a substantially longitudinal fillet slot; and
a plurality of corner members, each corner member having a profile that is complementary with, and longitudinally movable within, said fillet slot for abutting two fillet segments, keeping said abutted fillets in rigid alignment in all axes, and providing a flexible expansion joint for said abutted fillets.

2. The fillet assembly of claim 1, said fillet segments defining a decorative portion and a shelf portion, said shelf portion providing a support surface for engagement with said mat board to secure said fillet assembly to said mat board.

3. The fillet assembly of claim 1, each corner member further comprising a ridge formed thereon for keeping abutted fillet segments rigidly in a plane of said fillet assembly.

4. The fillet assembly of claim 1, each corner member further comprising tapered ends for easy insertion into a corresponding fillet slot.

5. The fillet assembly of claim 1, where said fillet segments are fabricated from a plastic material by extrusion.

6. The fillet assembly of claim 1, each fillet segment slot defining a gap and a further portion having a diameter is that is larger than that of said gap for maintaining rigid positioning of abutted fillet segments in all spatial axes.

7. The fillet assembly of claim 6, wherein the further portion comprises an extruded cylinder of any desired shape that is larger than said gap, wherein rotated of an inserted fillet segment in the plane of the gap is prevented.

8. The fillet assembly of claim 2, wherein distortion that occurs from flexing a fillet segment during cutting only produces distortion in a mitered cut on the fillet segment shelf portion, which portion is concealed under said mat board and, therefore, not visible in a final fillet and mat board assembly.

9. The fillet assembly of claim 1, where said fillet segments are fabricated from any of high impact polystyrene (HIPS) and acrylo butadiene styrene (ABS).

10. The fillet assembly of claim 1, wherein defined areas of each fillet segment are hot stamped to import a decorative impression thereto.

11. The fillet assembly of claim 1, each corner member having two end portions, each of which is capable of engagement within a fillet member slot, each corner member further comprising an extended tip at each end thereof for easier positioning of said corner member within said fillet member slot.

12. The fillet assembly of claim 1, where said corner members are fabricated from any of high impact polystyrene (HIPS) and acrylo butadiene styrene (ABS).

13. The fillet assembly of claim 1, each fillet member having a hollow profile.

14. The fillet assembly of claim 1, said corner members comprising an “L” shaped insert.

15. In a fillet assembly for a picture frame mat board, a fillet segment comprising:
a fillet segment having a profile defining a substantially longitudinal fillet slot for receiving a corner member for abutting two fillet segments, keeping said abutted fillets in rigid alignment in all axes, and providing a flexible expansion joint for said abutted fillets, wherein a plurality of fillet segments can be pre-joined into a self supporting polygonal assembly before mounting into a complementary aperture formed in a mat board.

16. In a fillet assembly for a picture frame mat board, a corner member comprising:
a corner member having a profile that is complementary with, and longitudinally movable within a fillet segment for keeping abutted fillets in rigid alignment in all axes, and providing a flexible expansion joint for said abutted fillets, wherein a plurality of fillet segments can be pre-joined into a self supporting polygonal assembly before mounting into a complementary aperture formed in a mat board.

17. A fillet for a picture frame mat board, comprising:
an injection molded, one piece member, said member being resilient wherein it can be flexed into locking abutment within an aperture formed in said mat board to form a unitary assembly.

18. The fillet of claim 17, further comprising an engagement surface having an undercut.

19. The fillet of claim 18, wherein said undercut is in the range of 0.005 to 0.030-inches.

20. The fillet of claim 17, said member having sufficient resilience to sustain bending forces that are used to flex the fillet so it can be installed into the mat board without damaging the mat board.

21. The fillet of claim 17, further comprising:
a plurality of reinforcement ribs for providing rigidity to said fillet.

22. The fillet of claim 17, said member further comprising:
a lip for engagement with a surface of said mat board to secure said member to said mat board.

23. A method for installing a fillet into a mat board, comprising the steps of:
providing either of:
a fillet assembly comprised of a plurality of fillet segments pre-joined into a self supporting polygonal assembly before mounting into a complementary aperture formed in a mat board, said fillet assembly comprising an engagement surface having a undercut; and
an injection molded, one piece member, said member being resilient wherein it can be flexed into locking abutment within an aperture formed in said mat board to form a unitary assembly, said member comprising an engagement surface having a undercut;
cutting an aperture in said mat board to match the dimensions of said fillet undercut;
either of pressing said fillet assembly or said member into said mat board where it is secured by a lip resulting from said undercut or, flexing said fillet assembly or said member to position it within the aperture in the mat board and then releasing the flexing forces on the member, thus securing the member within the aperture.

24. A method for installing a fillet into a mat board, comprising the steps of:
providing either of:
a fillet assembly comprised of a plurality of fillet segments pre-joined into a self supporting polygonal assembly before mounting into a complementary aperture formed in a mat board; and
an injection molded, one piece member, said member being resilient wherein it can be flexed into locking abutment within an aperture formed in said mat board to form a unitary assembly; and
then cutting a correct aperture size in a mat board.
